(19) United States
(12) Patent Application Publication
(10) Pub. No.: US 2008/0116192 A1
(43) Pub. Date: May 22, 2008

(54) Injection molding of ceramic elements

(75) Inventors: Suresh Annavarapu, Somerville, MA (US); Taehwan Yu, Sudbury, MA (US); Norman P. Arsenault, Holden, MA (US); Craig A. Willkens, Sterling, MA (US)

Correspondence Address: EDWARDS ANGELL PALMER & DODGE LLP, P.O. BOX 55874, BOSTON, MA, 02205, US

(73) Assignee: Saint-Gobain Ceramics & Plastics, Inc., Worcester, MA (US)

(21) Appl. No.: 11/906,759

(22) Filed: Oct. 2, 2007

Related U.S. Application Data
(60) Provisional application No. 60/849,154, filed on Oct. 2, 2006.

(51) Int. Cl. F23Q 7/22; H05B 3/48; H05B 3/42; H05B 3/00

(52) U.S. Cl. 219/270; 219/553; 29/611

(57) ABSTRACT

The invention provides new methods for manufacture ceramic resistive heating elements that include forming a heating element body comprising comprises two or more regions of differing resistivity, and processing a portion of the element body to form a heating element. Heating elements such as igniters and glow plugs also are provided obtainable from fabrication methods of the invention.

The present application claims the benefit of U.S. provisional application No. 60/849,154 filed Oct. 2, 2006, which is incorporated herein by reference in its entirety.

### BACKGROUND

1. Field

The invention includes new methods for manufacture of ceramic resistive heating elements that include forming a heating element body comprising two or more regions of differing resistivity, and processing a portion of the element body to form a heating element. Heating elements such as igniters and glow plugs also are provided obtainable from fabrication methods of the invention.

2. Background

Ceramic materials have enjoyed great success as igniters in e.g. gas-fired furnaces, stoves and clothes dryers. Ceramic igniter production includes constructing an electrical circuit through a ceramic component a portion of which is highly resistive and rises in temperature when electrified by a wire lead. See, for instance, U.S. Pat. Nos. 6,582,629; 6,278,087; 6,028,292; 5,801,361; 5,786,565; 5,405,237; and 5,191,508.

Typical igniters have been generally rectangular-shaped elements with a highly resistive “hot zone” at the igniter tip with one or more conductive “cold zones” providing to the hot zone from the opposing igniter end. One currently available igniter, the Mini-Igniter™, available from Norton Igniter Products of Milford, N.H., is designed for 12 volt through 120 volt applications and has a composition comprising aluminum nitride (“AlN”), molybdenum disilicide (“MoSi₂”), and silicon carbide (“SiC”).

Current ceramic igniters also have suffered from breakage during use, particularly in environments where impacts may be sustained such as igniters used for gas cooktops and the like.

It thus would be desirable to have new ignition systems. It would be particularly desirable to have new methods for producing ceramic resistive elements. It also would be desirable to have new heating elements that have good mechanical integrity.

### SUMMARY

New methods for producing ceramic heating elements are now provided which include forming a heating element body comprising two or more regions of differing resistivity, and processing a portion of the element body to form a functional heating element.

In preferred aspects, processing comprises removing portions of a conductive or insulator region to thereby define an electrical circuit and provide a functional heating element.

We have found that such methods can enable efficient production of heating elements of high mechanical strength.

In preferred aspects, one or more ceramic materials are deposited via slip casting to form the heating element body. Other forming methods also may be employed such as extrusion, dip coating, spray coating, injection molding, and other processes.

After deposition of ceramic materials to form the heating element body, the body element can be further processed to provide a functional heating element. In particular, in preferred aspects, one or more regions of a heating element body may be removed such as by machining to form a functional electrical pathway (circuit). That is, in certain aspects, prior to such processing, the formed heating element body may comprise one or more conductive regions that provide a latent but non-functional electrical circuit. The further processing can define an electrical circuit and enable the thus-formed element to function as a ceramic heater, such as an igniter.

In one exemplary system, an outer region of a heating element body is highly conductive with the element body distal end tapered (decreased cross-sectional area) to enable resistive heating. The element body is then processed to remove opposed conductive regions areas from the body proximal end toward the element body distal end. Such processing thereby defines an electrical circuit from the outer conductive region.

In another exemplary system, a drain cast (slip cast) application may be employed. For example, an outer resistive (hot or ignition zone) skin may be formed by a drain cast application and that conductive skin filled with an insulator region. A conductive zone then can be applied e.g. from the element's proximal end toward the element distal end to define an isolated resistive area at the element distal end. For instance, such a third zone that is provided by a conductive composition could be readily dip coated onto the two-region element.

In certain preferred aspects, processing (e.g. removal of selected portion(s)) of a heating element body may be facilitated by including topography in the element body. For instance, the heating element body may include two or more protruding sections that can be readily removed to define an outer electrical circuit. The protruding sections may be for example two sections that extend on opposed faces of the element body for at least a substantial portion of the body length.

In certain aspects, the processing may provide an extended electrical pathway which can provide for higher operational voltages. Such extended electrical pathways may have a variety of configurations to provide for greater lengths. For instance, a serpentine or helical electrical pathway may be employed.

Preferred heating elements of the invention may comprise regions of differing resistivity through a cross-section of the element, including an inner insulator region and outer resistive and/or conductive regions as discussed above. In other embodiments, an inner conductive region and outer insulator region may be employed.

Preferred ceramic elements obtainable by methods of the invention comprise a first conductive zone, a resistive hot zone, and a second conductive zone, all in electrical sequence. Preferably, during use of the device electrical power can be applied to the first or the second conductive zones through use of an electrical lead (but typically not both conductive zones). As discussed above, processing of a formed heating element body can define the first and second conductive zones as well as a resistive heating portion.

Particularly preferred heating elements of the invention of the invention will have a rounded cross-sectional shape along at least a portion of the heating element length (e.g., the length extending from where an electrical lead is affixed to the heating element to a resistive hot zone). More particularly, preferred heating elements may have a substantially oval, circular or other rounded cross-sectional shape for at least a portion of the heating element length, e.g. at least about 10 percent, 40 percent, 60 percent, 80 percent, 90 percent of the heating element length, or the entire heating element length. Such rod configurations can offer higher Section Moduli and hence can enhance the mechanical integrity of the heating element.

Particularly preferred heating elements also may be integral elements, i.e. the elements will be a solid ceramic element (no void space) through the cross-section of the element for the full length of the heating element. Such integral elements are distinct from elements that may include void spaces (e.g. one or more slots with no ceramic composition present) in at least a portion of the length/cross-section of the element.

Heating elements of the invention can be employed at a wide variety of nominal voltages, including nominal voltages of 6, 8, 9, 10, 12, 24, 120, 220, 230 and 240 volts.

Heating elements of the invention also can be useful for ignition in a variety of devices and heating systems. More particularly, heating systems are provided that comprise a sintered heating element as described herein. Specific heating systems include gas cooking units, heating units for commercial and residential buildings, including water heaters. Heating elements of the invention also may be useful as glow plugs e.g. for use in a combustion engine.

As referred to herein, “slip casting” indicates the general process of advancing a ceramic composition into a mold element with subsequent withdrawal of the formed element from the mold.

As typically referred to herein, the term “injection molded,” “injection molding” or other similar term indicates the general process where a material (here a ceramic or pre-ceramic material) is injected or otherwise advanced typically under pressure into a mold in the desired shape of the ceramic element followed by cooling and subsequent removal of the solidified element that retains a replica of the mold.

Other aspects of the invention are disclosed infra.

### BRIEF DESCRIPTION OF THE DRAWINGS

FIG. 1 shows a preferred heating element of the invention;

FIGS. 2A, 2B and 2C illustrate preferred process steps to produce a heating element;

FIGS. 3A, 3B and 3C illustrate preferred process steps to produce a heating element;

FIGS. 4A and 4B show further preferred heating elements of the invention; and

FIGS. 5A and 5B show a preferred heating element system of the invention. FIG. 4A is a front face of the heating element and FIG. 4B is the opposed rear face of that heating element.

### DETAILED DESCRIPTION

As discussed above, new methods for manufacture of ceramic resistive heating elements are provided that include forming a heating element body comprising comprises two or more regions of differing resistivity and processing a portion of the element body to form a heating element. In preferred aspects, processing comprises removing portions of a conductive or insulator region to thereby define an electrical circuit and provide a functional heating element.

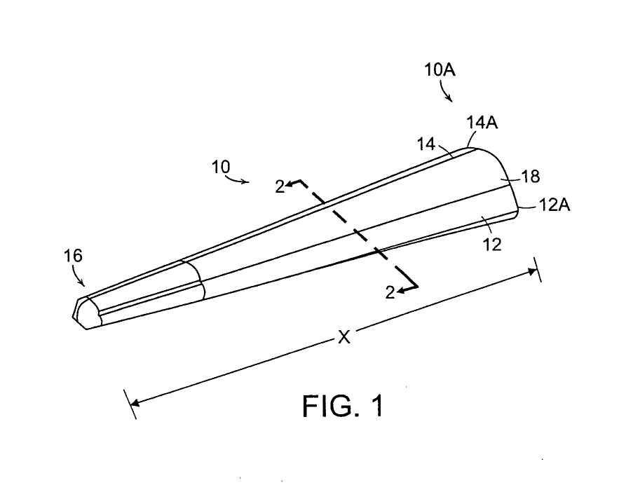

Referring now to the drawings, FIG. 1 shows a preferred heating element 10 which includes conductive regions 12 and 14 that provide an electrical circuit and extend along the element's length. Element distal region 16 is tapered (decreased cross-sectional area) to thereby provide resistive heating in that region. Core insulator region 18 separates conductive regions 12 and 14 and thereby defines an electrical circuit.

In use, power can be supplied to heating element 10 (e.g. via one or more electrical leads, not shown) through proximal ends 12A and 14A of the conductive regions 12 and 14. Electrical leads may be affixed to proximal ends 12A and 14A such as through brazing. The heating element proximal end 10A suitably may be mounted within a variety of fixtures, such as where a ceramoplastic sealant material encases conductive element proximal ends 12A and 14A. Such encasing with a sealant material is disclosed in U.S. Pat. No. 6,933,471. Metallic fixtures also may be suitably employed to encase the heating element proximal end.

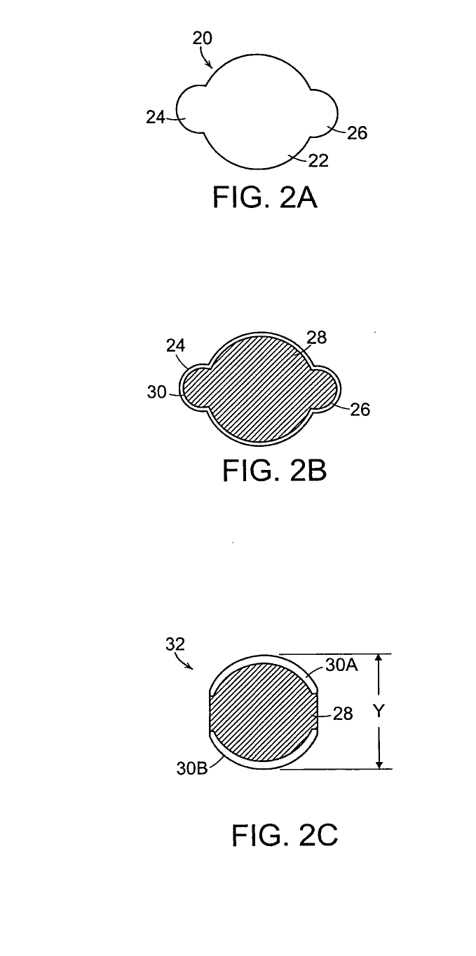

FIGS. 2A through 2C illustrate in cross-section (such as along 2-2 of FIG. 1) preferred processing steps of methods of the invention.

Thus, as shown in FIG. 2A, a slip cast mold 20 can be utilized of the general depicted configuration to provide a rod-shaped heating element body 22 with opposed protruding regions 24 and 26. In one system, the slip cast mold 20 can be filled with an insulator ceramic composition. A rigid element may be provided by removal of binding agent(s).

As generally illustrated in FIG. 2B, an encasing conductive composition 30 then can be applied around the slip cast insulator region 28. That conductive composition 30 may be applied e.g. by another slip casting application or other means such as dip coating to thereby form a heating element 22 with two regions (28, 30) of differing resistivity.

As shown by FIG. 2C, protruding regions 24 and 26 then can be removed such as by machining to define an electrical pathway and provide a functional heating element 32. Such processing of the element body may be done with the element body in a green or sintered state. Thus, by processing of regions 24 and 26, particularly removal thereof, insulator 28 bisects separated conductive zones 30A and 30B which define an electrical pathway. In use, current can flow the length of heating element through conductive zone 30A and distal tapered resistive area and then back down the length of the heating element through conductive zone 30B.

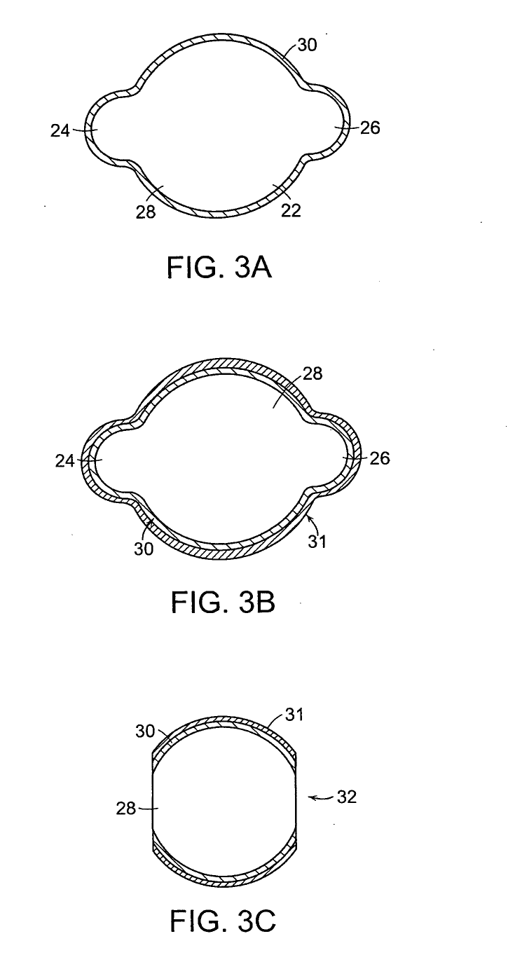

FIGS. 3A through 3C illustrate in cross-section (such as along 2-2 of FIG. 1) further preferred processing steps of methods of the invention to provide heating elements having greater than two regions of differing resistivity (e.g. three or more regions of differing resistivity such as conductive, insulator and resistive (hot or ignition) regions of differing resistivity and ceramic composition).

Thus, as discussed above with respect to FIGS. 2A-2C, and as shown in FIG. 3A, a slip cast mold can be utilized of the general depicted configuration to provide a rod-shaped heating element body with opposed protruding regions 24 and 26. In one system, the slip cast mold 20 can be filled with an insulator ceramic composition 28. A rigid element may be provided by removal of binding agent(s).

As generally illustrated in FIG. 3B, an encasing resistive composition 30 then can be applied around a slip cast mold to provide a resistive shell. The shell core then may be filled with an insulator composition to provide insulator region 28. The resistive composition 30 may be applied e.g. by another slip casting application or other means such as dip coating.

Thereafter, as also generally illustrated in FIG. 3B, an encasing conductive composition 31 then can be applied around resistive composition layer 30. That conductive composition 31 may be applied e.g. by slip coating or other means such as dip coating to thereby form a heating element 22 with three regions (28, 30 and 31) of differing resistivity.

As shown by FIGS. 2C and 3C, protruding regions 24 and 26 then can be removed such as by machining to define an electrical pathway and provide a functional heating element 32. Such processing of the element body may be done with the element body in a green or sintered state. Thus, by processing of regions 24 and 26, particularly removal thereof, insulator 28 bisects separated conductive zones 30A and 30B which define an electrical pathway. In use, current can flow the length of heating element through conductive zone 30A and distal tapered resistive area and then back down the length of the heating element through conductive zone 30B.

While in certain embodiments slip casting may be a preferred approach to fabricate a heating element, other forming methods also may be suitably employed, either in addition to or entirely in place of slip casting. For instance, extrusion molding, injection molding and/or dip coating applications of ceramic compositions to form a heating element body and a formed (functional) heating element may be employed. Extrusion molding to form a heating element is disclosed in International Publication WO 2006/050201. Injection molding to form a heating element is disclosed in International Publication WO 2006/086227.

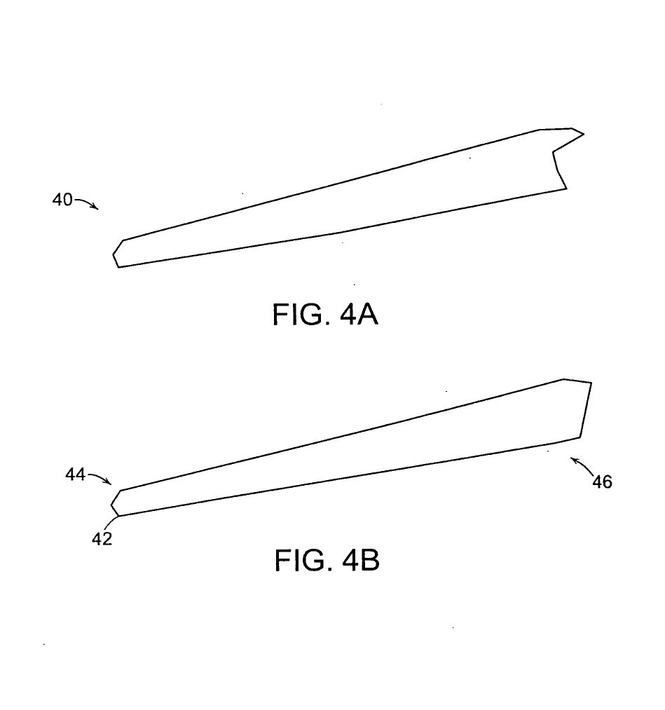

FIGS. 4A and 4B depict heating system elements as may be fabricated via a drain casting process. In particular, FIG. 4A shows in cut-away view a ceramic resistive (hot or ignition zone) conductive shell 40 formed through a drain casting process, e.g., where a resistive ceramic slurry is poured into a slip cast mold and then the slurry is poured from the mold shortly thereafter such as less than 5, 4, 3, 2, 1, 0.5 or 0.25 minutes after the slurry is first introduced into the mold. The remaining resistive ceramic coating layer then may be dried and an insulator ceramic composition introduced into the shell within the slip casting mold. That two-region composite body can be dried overnight and then removed from the slip casting mold optionally with the assistance of agitation (e.g. vibration). The thus obtained heating element body 42 (shown in cross-section in FIG. 4B) can be further dried if desired e.g. for 1 or more hours at elevated temperatures such as 100 to 150° C.

A conductive zone can be incorporated into ceramic body proximal end such as dip coating a conductive ceramic composition from the element's proximal end toward the element distal end 46 to thereby define the resistive zone area beyond the application of the conductive outer layer. The three-zone or region ceramic body can be further dried if desired e.g. for 1 or more hours at elevated temperatures such as 100 to 150° C.

Other regions of distinct resistivity also may be included into the heating element body such as through dip coating or other application method. For instance, for certain systems, it may be desirable to include a power booster or enhancement zone of intermediate resistance in the electrical circuit pathway between the most conductive portions of that pathway and the highly resistive (hot) regions of that pathway. Such booster zones of intermediate resistance are described in U.S. Patent application Publication 2002/0150851 to Willkens.

Preferred booster zones will have a positive temperature coefficient of resistance (PTCR). Preferably, the booster zone has an intermediate resistance that will permit i) effective current flow to the igniter hot zone, and ii) some resistance heating of the booster region during use of the igniter, although preferably the booster zone will not heat to as high temperatures as the hot zone during use of the igniter.

During use, the multiple resistance zones of a heating element suitably exhibit distinct resistance and temperature values. Thus, in preferred systems that comprise as booster zone, the first conductive zone preferably exhibits the least resistance of the three zones, the booster zone a relatively higher resistance, and the hot or ignition zone exhibits the highest resistance of the igniter.

Such multiple zone systems that comprises a booster zone typically exhibit an analogous temperature gradient during use. That is, the conductive zone will not substantially heat during use; the hot or ignition will heat to a temperature e.g. sufficient to heat a fuel source such as at least about 1000° C., more typically at least about 1200° C. or 1300° C.; and the interposed booster zone will typically heat to within the range of from about at least 100, 200, 300 or 400° C. greater than the conductive zone and at least about 100, 200, 300 or 400° C. less than the hot zone.

At room temperature (ca. 25° C.), the conductive zone preferably will have a resistance that is no more than about 50%, 25%, 10% or 5% of the room temperature resistance of the booster zone, and preferably the conductive zone will have a room temperature resistance that is no more than about 10%, 5% or 1% of the room temperature resistance of the booster zone. The conductive zone should exhibit minimal resistance during heating.

At room temperature, the booster zone preferably will have a resistance that is no more than about 75%, 50%, 25%, 10% or 5% of the hot zone. During use however, the resistance of the hot zone may suitable exceed the operational temperature resistance of the hot zone. For example, during use at operational temperatures (e.g. hot zone at least about 1000° C. or 1100° C.), the resistance of the booster zone resistance may be at least about 110%, 120%, 130%, 140%, 150%, 160%, 170%, 180%, 190%, 200%, 220%, 250%, 270% or 300% of the operational temperature resistance of the hot zone.

In heating element bodies of the invention, the formed multiple-zone element body then can be processed to form an electrical circuit, particularly by removal of a conductive zone along the length of the ceramic body from the body distal proximal end 46 to the resistive zone at the body distal end to thereby define an electrical pathway. Sintering may be performed before or after such processing to define the electrical pathway.

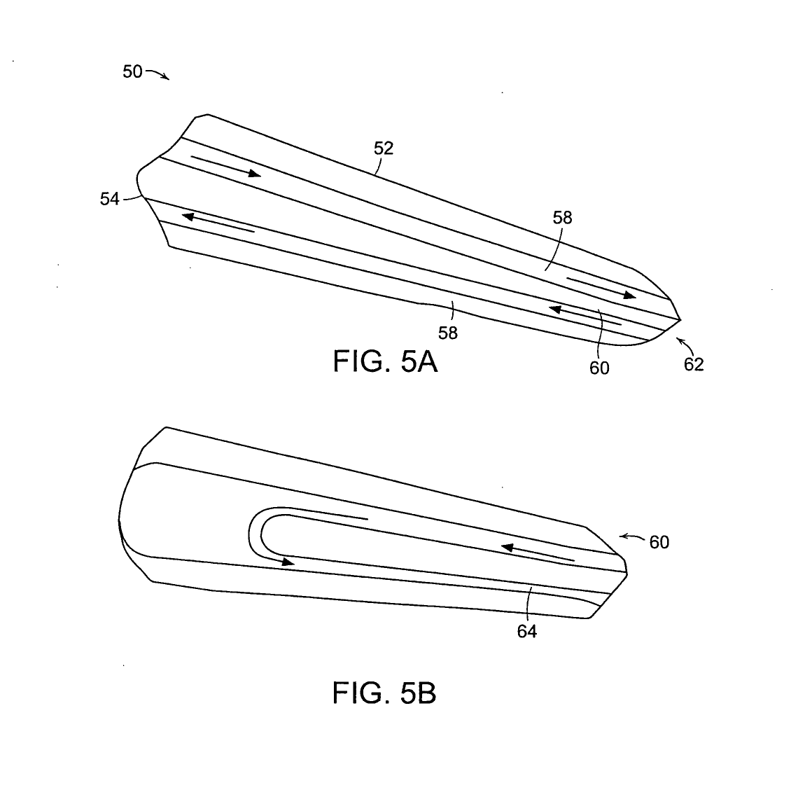

FIGS. 5A and 5B depict a further preferred heating element system 50 where insulator regions 52, 54 and 56 define the depicted electrical pathway through conductive zones 58 and 60. Resistive heating occurs at tapered end portion 62.

In this system 50, a conductive region forms the interior of element 50 with an outer insulator. Insulator regions 52, 54 and 56 which define the depicted serpentine electrical pathway can be provided by selective machining of the outer insulator. Other non-linear electrical pathways such as coil-shaped pathways can be utilized to extend the pathway length and thereby enable the heating element to operate at higher voltages.

Formed heating elements may be further processing as desired. For instance, additional ceramic compositions may be applied to the formed element. Thus, for example, a heating element may be encased such as by dip coating with an insulator composition to enhance performance of the element's electrical pathway, such as to prevent arcing between adjacent conductive regions. Such arcing can be particularly problematic if the heating element is used with wet fuels (e.g., kerosene, gasoline, heating oil, etc.) Application of an exterior insulator coating layer to the heating element can significantly minimize such arcing.

For dip coating applications, a slurry or other fluid-like composition of the ceramic composition may be suitably employed. The slurry may comprise water and/or polar organic solvent carriers such as alcohols and the like and one or more additives to facilitate the formation of a uniform layer of the applied ceramic composition. For instance, the slurry composition may comprise one or more organic emulsifiers, plasticizers, and dispersants. Those binder materials may be suitably removed thermally during subsequent densification of the heating element.

Additionally, a heating element may include additional functions such as a thermocouple circuit, flame sensor or flame rectifier.

A heating element also may include a resistive heating region of a distinct ceramic composition. For instance, a heating element may comprise conductive, hot (resistive heating) and insulator regions (i.e. a three region system), where each of such regions has a differing ceramic composition.

The formed heating element preferably is further densified such as under conditions that include elevated temperature and pressure. In particular, after forming an heating element may be sintered in a single or multiple step thermal treatment.

In one multiple step protocol, a heating element formed through a slip casting and dip coating process may be subjected to a first thermal treatment to remove various organic and inorganic carrier materials, e.g. heating at above 1000° C. in an inert atmosphere such as argon to remove binders and the like. Thereafter, the heating element may be sintered in excess of 1600° C. for 0.5 hours or more under pressure.

As discussed above, and exemplified by the heating elements in the figures, in certain preferred systems, at least a substantial portion of the heating element length has a rounded cross-sectional shape along at least a portion of the heating element length, such as length x shown in FIG. 1. Heating element 10 of FIG. 1 depicts a particularly preferred configuration where heating element 10 has a substantially circular cross-sectional shape for about the entire length of the heating element to provide a rod-shaped element. However, preferred systems also include those where only a portion of the heating element has a rounded cross-sectional shape, such as where up to about 10, 20, 30, 40, 50, 60, 70 80 or 90 of the heating element length (as exemplified by heating element length x in FIG. 1) has a rounded cross-sectional shape; in such designs, the balance of the heating element length may have a profile with exterior edges.

Dimensions of heating elements of the invention may vary widely and may be selected based on intended use of the heating element. For instance, the length of a preferred heating element (length x in FIG. 1) suitably may be from about 0.5 to about 5 cm or more, more preferably from about 1 about 3 cm, and the heating element cross-sectional width may suitably be from about (length y in FIG. 2C) suitably may be from about 0.2 to about 3 cm.

In certain preferred systems, the hot or resistive zone of a heating element of the invention will heat to a maximum temperature of less than about 1450° C. at nominal voltage; and a maximum temperature of less than about 1550° C. at high-end line voltages that are about 110 percent of nominal voltage; and a maximum temperature of less than about 1350° C. at low-end line voltages that are about 85 percent of nominal voltage.

A variety of compositions may be employed to form a heating element of the invention. Ceramic compositions of differing resistivies are suitably employed to form a heating element body as discussed above.

In certain embodiments, if a separate ceramic composition is employed to form a hot zone region, generally preferred hot zone compositions comprise at least three components of 1) conductive material; 2) semiconductive material; and 3) insulating material. Conductive (cold) and insulative (heat sink) regions may be comprised of the same components, but with the components present in differing proportions. Typical conductive materials include e.g. molybdenum disilicide, tungsten disilicide, nitrides such as titanium nitride, and carbides such as titanium carbide. Typical semiconductors include carbides such as silicon carbide (doped and undoped) and boron carbide. Typical insulating materials include metal oxides such as alumina or a nitride such as AlN, SiALON (i.e. a silicon aluminum oxynitiride material) and/or Si₃N₄.

As referred to herein, the term electrically insulating material indicates a material having a room temperature resistivity of at least about 10¹⁰ ohms-cm. The electrically insulating material component of heating elements of the invention may be comprised solely or primarily of one or more metal nitrides and/or metal oxides, or alternatively, the insulating component may contain materials in addition to the metal oxide(s) or metal nitride(s). For instance, the insulating material component may additionally contain a nitride such as aluminum nitride (AlN), silicon nitride, SiALON, or boron nitride; a rare earth oxide (e.g. yttria); or a rare earth oxynitride.

As referred to herein, a semiconductor ceramic (or “semiconductor”) is a ceramic having a room temperature resistivity of between about 10 and 10⁸ ohm-cm. If the semiconductive component is present as more than about 45 v/o of a hot zone composition (when the conductive ceramic is in the range of about 6-10 v/o), the resultant composition becomes too conductive for high voltage applications (due to lack of insulator). Conversely, if the semiconductor material is present as less than about 5 v/o (when the conductive ceramic is in the range of about 6-10 v/o), the resultant composition becomes too resistive (due to too much insulator). Again, at higher levels of conductor, more resistive mixes of the insulator and semiconductor fractions are needed to achieve the desired voltage. Typically, the semiconductor is a carbide from the group consisting of silicon carbide (doped and undoped), and boron carbide.

As referred to herein, a conductive material is one which has a room temperature resistivity of less than about 10⁻² ohm-cm. If the conductive component is present in an amount of more than 35 v/o of the hot zone composition, the resultant ceramic of the hot zone composition, the resultant ceramic can become too conductive. Typically, the conductor is selected from the group consisting of molybdenum disilicide, tungsten disilicide, and nitrides such as titanium nitride, and carbides such as titanium carbide. Molybdenum disilicide is generally preferred.

In general, if employed, suitable hot (resistive) zone compositions include (a) between about 50 and about 80 v/o of an electrically insulating material having a resistivity of at least about 1010 ohm-cm; (b) between about 5 and about 45 v/o of a semiconductive material having a resistivity of between about 10 and about 10⁸ ohm-cm; and (c) between about 5 and about 35 v/o of a metallic conductor having a resistivity of less than about 10⁻² ohm-cm. Preferably, the hot zone comprises 50-70 v/o electrically insulating ceramic, 5-45 v/o of the semiconductive ceramic, and 5-20 v/o of the conductive material.

Preferred cold zone (conductive) regions include those that are comprised of e.g. AlN and/or Al₂O₃ or other insulating material; SiC or other semiconductor material; and MoSi₂ or other conductive material.

If employed in a heating element, preferred booster zone compositions may comprise the same materials as the conductive and hot zone region compositions, e.g. preferred booster zone compositions may comprise e.g. AlN and/or Al₂O₃, or other insulating material; SiC or other semiconductor material; and MoSi₂ or other conductive material. A booster zone composition typically will have a relative percentage of the conductive and semiconductive materials (e.g., SiC and MoSi₂) that is intermediate between the percentage of those materials in the hot and cold zone compositions. A preferred booster zone composition comprises about 60 to 70 v/o aluminum nitride, aluminum oxide, or other insulator material; and about 10 to 20 v/o MoSi₂ or other conductive material, and balance a semiconductive material such as SiC. A specifically preferred booster zone composition for use in igniters of the invention contains 14 v/o MoSi₂, 20 v/o SiC and balance v/o Al₂O₃. A specifically preferred booster zone composition for use in igniters of the invention contains 17 v/o MoSi₂, 20 v/o SiC and balance Al₂O₃. A further specifically preferred booster zone composition for use in igniters of the invention contains 14 v/o MoSi₂, 20 v/o SiC and balance v/o AlN. A still farther specifically preferred booster zone composition for use in igniters of the invention contains 17 v/o MoSi₂, 20 v/o SiC and balance AlN.

Heating elements of the present invention may be used in many applications, including gas phase fuel ignition applications such as furnaces and cooking appliances, baseboard heaters, boilers, and stove tops. In particular, a heating element of the invention may be used as an ignition source for stove top gas burners as well as gas furnaces.

Heating elements of the invention also are particularly suitable for use for ignition where liquid (wet) fuels (e.g. kerosene, gasoline) are evaporated and ignited, e.g. in vehicle (e.g. car) heaters that provide advance heating of the vehicle.

Heating elements of the invention also are suitably employed as glow plugs, e.g. as an ignition source in a motor vehicle.

Heating elements of the invention will be useful for additional specific applications, including as a heating element for an infrared heater.

The following non-limiting examples are illustrative of the invention. All documents mentioned herein are incorporated herein by reference in their entirety.

### EXAMPLE 1

### Heating Element Fabrication

A heating element of the invention of the general configuration shown in FIG. 1 of the drawings may be prepared as follows.

Powders of an insulator composition (90 volume % Al₂O₃ and about 10 volume % MoSi₂) are mixed with deinoized water, citric acid and 2 weight percent of epoxy resin binder. The composition may be ball milled for 6 to 8 hours.

The insulator composition is advanced into a slip molding cast of the shape depicted in FIG. 2A of the drawings. The composition may be allowed to sit in the mold overnight and then the formed element body may be removed from the mold. The removed element body is dried for one hour at 140° C.

A conductive ceramic composition for dip coating application is prepared by mixing ceramic powders (63 volume % Al₂O₃, about 30 volume % MoSi₂, and 7 volume % SiC) with water and epoxy resin binder.

The formed insulator body element is then dip coated with the conductive ceramic composition. The coated element body with two ceramic regions of differing resistivity is then dried for one hour at 140° C.

The element body is then sintered at 1500 to 1600° C. under pressure.

Thereafter, the protruding “ear” portions (regions 24 and 26 in FIG. 2B) are removed by machine grinding to define the electrical circuit and provide a functioning heating element of the general configuration shown in FIGS. 1 and 2C.

Electrical leads are then attached via brazing to the conductive regions of the heating element proximal end.

### EXAMPLE 2

### Heating Element Fabrication with Drain Casting

A heating element of the invention of the general configuration illustrated in FIGS. 4A and 4B of the drawings may be prepared as follows.

A resistive ceramic composition application is prepared by mixing ceramic powders (63 volume % Al₂O₃, about 22 volume % MoSi₂, and 5 volume % SiC) with water and epoxy resin binder. That composition is introduced into a slip casting mold. Within about five seconds after that introduction, the slip casting mold is inverted to remove the conductive composition and leave a skin layer of the ceramic composition on the walls of the mold.

Powders of an insulator composition (90 volume % Al₂O₃ and 10 volume % MoSi₂) are mixed with deinoized water, citric acid and 2 weight percent of epoxy resin binder. The composition is introduced into the slip casting mold with inner skin layer of the ceramic composition.

The insulator composition is advanced into a slip molding cast of the shape depicted in FIG. 2A of the drawings. The composition may be allowed to sit in the mold overnight and then the formed element body may be removed from the mold. The removed element body is dried for one hour at 140° C.

That two-region composite body is dried overnight and then removed from the slip casting mold with vibration of the mold. The thus obtained heating element body is dried for 1 hour 140° C.

A conductive ceramic composition for dip coating application is prepared by mixing ceramic powders (63 volume % Al₂O₃, about 30 volume % MoSi₂, and 7 volume % SiC) with water and epoxy resin binder.

That conductive zone composition is incorporated into ceramic body proximal end until defining the element's resistive zone at the element distal end. The three-zone ceramic body is dried for 1 hour at 140° C. following by sintering at 1730° C.

The sintered three-zone element is then processed to form an electrical circuit, particularly by removal of a conductive zone along the length of the ceramic body from the body distal proximal end to the resistive zone at the body distal end to thereby define an electrical pathway.

Electrical leads are then attached via brazing to the conductive regions of the heating element proximal end.

The invention has been described in detail with reference to particular embodiments thereof. However, it will be appreciated that those skilled in the art, upon consideration of this disclosure, may make modification and improvements within the spirit and scope of the invention.

1. A method for producing a resistive ceramic heating element, comprising:
forming a heating element body comprising comprises two or more regions of differing resistivity; and
processing a portion of the element body to form a heating element.

2. The method of claim 1 wherein processing defines an electrical pathway of the heating element.

3. The method of claim 1 or 2 wherein processing comprising removing one or more portions of the element body.

4. The method of claim 1 or 2 wherein processing comprises removing one or more protruding sections of the heating element body.

5. The method of claim 4 wherein removing comprises removing two opposed sections of the heating element body.

6. The method of claim 1 wherein the element body comprises three or more regions of differing resisitivity.

7. The method of claim 6 wherein the heating element body comprises insulator, conductive and resistive (ignition) zones.

8. The method of claim 6 wherein the heating element body comprises insulator, conductive, booster and resistive (ignition) zones.

9. The method of claim 1 wherein the heating element body comprises regions of differing resistivity through a cross-section of the heating element.

10. The method of claim 1 wherein the heating element body comprises an inner insulator region and outer conductive region.

11. The method of claim 1 wherein the heating element body is formed at least is part by slip casting.

12. The method claim 1 wherein the heating element body is formed at least is part by dip coating.

13. The method of claim 1 the heating element has a substantially rounded cross-sectional shape for at least a portion of the heating element length.

14. The method of claim 1 wherein the heating element is an integral element.

15. A method for producing a resistive ceramic heating element, comprising:
slip casting ceramic material to form a heating element body;
processing a portion of the element body to form a heating element.

16. The method of claim 15 wherein slip casting comprises deposition of at least two distinct ceramic materials to form a heating element body.

17. The method of claim 15 or 16 wherein processing defines an electrical pathway of the heating element.

18. The method of claim 15 wherein processing comprising removing one or more portions of the element body.

19. A ceramic heating element obtainable by a method of claim 1 or claim 15.

20. A heating element body comprising comprises (i) two or more regions of differing resistivity and (ii) one or more protruding sections.

21. The heating element body of claim 20 wherein the heating element body comprises an inner insulator region and outer conductive region.

22. A method of igniting gaseous fuel, comprising applying an electric current across a heating element of claim 19.

23. A method of claim 22 wherein the current has a nominal voltage of 6, 8, 10, 12, 24, 120, 220, 230 or 240 volts.

24. A heating apparatus comprising a heating element of claim 19.
